(19) United States
(12) Patent Application Publication
(10) Pub. No.: US 2015/0172412 A1
(43) Pub. Date: Jun. 18, 2015

(54) MANAGING DEPENDENCIES BETWEEN OPERATIONS IN A DISTRIBUTED SYSTEM

(71) Applicant: Cornell University, Ithaca, NY (US)

(72) Inventors: Robert Escriva, Ithaca, NY (US); Emin Gun Sirer, Ithaca, NY (US); Bernard Wong, Kitchener (CA)

(21) Appl. No.: 14/412,105

(22) PCT Filed: Jul. 6, 2013
(86) PCT No.: PCT/US2013/049497

§ 371 Date: Dec. 30, 2014

Related U.S. Application Data
(60) Provisional application No. 61/668,929, filed on Jul. 6, 2012.

(51) Int. Cl. H04L 29/08

(52) U.S. Cl. CPC H04L 67/325; H04L 67/10

(57) ABSTRACT

An efficient fault-tolerant event ordering service as well as a simplified approach to transaction processing based on global event ordering determines the order of interdependent operations in a distributed system. The fault-tolerant event ordering service externalizes the task of tracking dependencies to capture a global view of dependencies between a set of distributed operations in a distributed system. A novel protocol referred to as linear transactions coordinates distributed transactions with Atomicity, Consistency, Isolation, Durability (ACID) semantics on top of a sharded data store. The linear transactions protocol achieves scalability by distributing the coordination task to only those servers that hold relevant data for each transaction and achieves high performance by serializing only those transactions whose concurrent execution could potentially yield a violation of ACID semantics.

### PRIORITY CLAIM

This application claims the benefit of U.S. Provisional Patent Application Ser. No. 61/668,929 filed Jul. 6, 2012.

### GOVERNMENT FUNDING

The invention described herein was made with government support under grant number CNS-1111698 awarded by the National Science Foundation. The United States Government has certain rights in the invention.

### FIELD OF THE INVENTION

The invention relates generally to determining the order of interdependent operations in a distributed system. Specifically, transactional updates to a sharded data store are coordinated to assign a time-order to the updates that comprise each transaction in a way that provides transactional atomicity, even though each update may be applied at each shard of the data store at a different local time.

### BACKGROUND OF THE INVENTION

A distributed system is a software system in which components located on networked computers communicate and coordinate their actions. The components interact with each other in order to achieve a common goal. Examples of distributed systems include, for example, service-oriented architecture (SOA) based systems, massively multiplayer online games, and peer-to-peer applications.

Time and event ordering are critical to the design of distributed systems. Time and event ordering determines the sequence of actions observed by clients and directly impacts the end-to-end correctness and consistency invariants a system may wish to maintain. Further, constraints placed on the ordering of events including, for example, atomic operations that take place within a single host such as the processing of a message, can have a significant impact on performance by enabling or limiting concurrency.

Because event ordering plays such a significant role, many techniques have been suggested to capture dependencies and ordering in distributed systems, for example, Lamport timestamps, vector clocks, and explicit time assignment. While these techniques differ in how they capture dependencies—whether they are expressed in a happens-before relationship, a time vector, or an assigned timestamp in a timeline —, they share the same architecture. Namely, they are instantiated separately within each independent distributed system and track dependencies solely within the purview of that system, often by monitoring communication at the boundaries of distributed components. This leads to a variety of problems including, for example, false negatives, false positives, and early assignment.

False negatives occur when the system misses any dependencies that are formed over external channels since the system only knows of relationships within its purview. Because false negatives have significant consequences, distributed systems often err by conservatively assuming a causal relationship even when a true dependence might not exist thereby creating false positives. For instance, many vector clock implementations establish a happens-before relationship between every message sent out and all messages received previously by the same network handler process, even if those messages did not play a causal role. Early assignment occurs when time ordering systems impose an order too early on concurrent events, thereby reducing the flexibility of the system. For instance, while Lamport clocks are space efficient, they reduce the ability to schedule concurrent events in a manner that would yield higher performance.

More specifically, the determination of the ordering of events in distributed systems was originally articulated as the motivation for Lamport timestamps, which captures happens-before relationships and provides a total ordering of events. Unfortunately, Lamport timestamps do not capture causality, as an event A with a smaller timestamp than an event B does not imply that A happened before B.

Vector clocks use a vector of logical clocks to express happens-before and concurrent relationships between events. In the worst case, vector clocks require as many entries as parallel processes in the system and exhibit significant overhead in deployments where there is a high-rate of node or process churn. There has been much work on improving vector clocks. Clock trees provide support for nested fork-join parallelism. Plausible clocks offer constant size timestamps while retaining accuracy close to vector clocks and hierarchical vector clocks provide more compact timestamps and adapt to the structure of the underlying network.

Modern networked applications, including almost all high-performance web services, are increasingly built on top of multiple distributed systems, and require a notion of dependence that carries over and composes between multiple independent subsystems.

Furthermore, data stores are used to connect to data, whether the data is stored in a database or in one or more files. Specifically, a data store is a data repository of a set of integrated objects modeled using classes defined in database schemas. Some data stores represent data in only one schema, while other data stores use several schemas. Examples of data stores include, for example, MySQL, PostgreSQL, and NoSQL.

As part of efforts to improve horizontal scalability, many modern large-scale web applications and services utilize some type of sharded NoSQL storage system to store and serve user and application related data. For example, Amazon EC2 users are encouraged to build their applications to utilize S3, Amazon's simple storage service, to scalably maintain persistent state. Data consistency guarantees offered by different NoSQL storage systems vary; however, there are tradeoffs between performance and consistency with some systems offering only eventual consistency while others offer tunable consistency or strong consistency for single key operations. As web applications become more sophisticated and move beyond best-effort requirements, even strongly consistent single key operations are insufficient, e.g., a user account management application that debits funds from one account and deposits them into another. This is a common requirement for many e-commerce applications, a classic example for demonstrating the need for transactions and currently requires that such account data be stored in a separate relational database management system (RDBMS).

Consistent event ordering can be achieved by requiring that all participants reach a consensus on event order. There are many distributed consensus protocols whose representative examples include Paxos, a heavy-weight protocol primarily for crash-fault environments; causal multicast, a class of protocols that respect causal order when delivering messages; and multi-phase commit protocols, a class of protocols that ensure all participants in a distributed transaction agree on whether to commit or abort. However, these consensus protocols do not maintain event ordering in one location accessible to all members of a system.

Many systems internally manage event ordering and track inter-process communication to provide causal consistency. Representative storage system examples include Bayou, a replica management system that exchanges logs between nodes, allows for connection disruptions without preventing progress, and manages conflict resolution of causally conflicting operations through a set of user specified merge procedures; Depot and SPORC are cloud storage systems which employ variants of Fork-Join-Causal or Fork* consistency to enable practical cloud applications which can operate on untrusted cloud servers; and COPS, a wide-area storage system that offers Causal+ consistency guarantees. Causality is also useful for supporting speculative execution, and bug and fault detection. There is significant repeated effort in providing causal consistency to each of these applications. However, these systems experience redundancy and fail to guarantee causal consistency that span multiple applications.

There has also been significant recent efforts at offering efficient transaction processing for distributed storage systems. Sinfonia provides a mini-transaction primitive that allows consistent access to data and does not permit clients to interleave remote data store operations with local computation. Sinfonia relies on internal locks to provide atomicity and isolation and therefore may perform poorly under contention. In recent work, the storage system is factored into two components: a Transactional Component that handles locking and concurrency, and a Data Component that manages physical storage structure. This separation of transaction processing from data management offers limited benefits as separating the event-ordering management from the application. For example, G-store provides serializable transactions on top of HBase, but constantly changes the primary replica of objects. As another example, ecStore provides snapshot isolation on top of a horizontally scalable data layer. Both of these systems offer full-fledge transactions with heavy-weight concurrency control mechanisms that limit scalability. Other storage systems with transactional support include Walter and COPS-GT. Walter provides parallel snapshot isolation, and strong local guarantees. COPS-GT offers get transactions that give clients a Causal+ consistent view of multiple keys. Spanner and Megastore use Paxos to provide strong consistency. PNUTS allows batch operations which do not execute in isolation. CloudTPS uses two-phase commit to order transactions. Relational Cloud provides “database-as-a-service” which offers multi-tenancy, scalability, and privacy. HyperDex restricts the client interface to limit the scope of transaction processing and is horizontally scalable because transactions may cross server boundaries.

The current lack of transactional support in NoSQL storage systems is primarily a result of unacceptable performance overheads associated with classic distributed transaction processing protocols. Moreover, locks, multi-phase atomic commit protocols, and other complex and heavy-weight mechanisms classically employed for distributed transactions go against the core tenet of NoSQL systems, which is to offer fast, simple and scalable data access. A long-standing open problem with NoSQL storage systems is that they fail to support multi-key transactions. A multi-key transaction is a simplified transaction model that groups multiple key-based operations into one atomic operation. The abstraction does not permit a client to interleave local computation with remote operations. Instead, the client must specify all key operations in absolute terms at the start of a transaction. For storage systems that only offer basic read and write operations, the main use of multi-key transactions are to simultaneously issue updates to multiple keys together in one atomic unit without allowance for any value-dependent changes to the control flow. Fortunately, many NoSQL storage systems, such as HyperDex-v0.2 and Memcached, support conditional puts and gets, compare-and-swap, and other simple key-based conditional operators in addition to basic reads and writes. Multi-key transactions become significantly more powerful for these storage systems, where a transaction commits only if all of the conditions in the conditional operators are met. Although strictly less general than classic transactions, multi-key transactions provide a useful and important abstraction that satisfies the requirements of many modern web applications. However, multi-key transactions cannot be efficiently implemented on top of existing NoSQL storage systems.

Furthermore, NoSQL systems have emerged to meet the performance and scalability challenges posed by large data through their distributed architecture where the data is shared across all hosts in the cluster. However, this distributed architecture of NoSQL systems make it difficult to support Atomicity, Consistency, Isolation, Durability (ACID) transactions. Distributed transactions are inherently difficult, because they require coordination among multiple servers. In traditional RDBMSs, transaction managers coordinate the clients and servers, and ensure that all participants in multi-phase commit protocols run in lock-step. Such transaction managers constitute bottlenecks, and modern NoSQL systems have eschewed them for more distributed implementations. Scatter and Google's Megastore map the data to different Paxos groups based on their key, thereby gaining scalability, but incur the latency of Paxos. An alternative approach that incurs comparable costs, pursued in Calvin, is to use a consensus protocol and deterministic execution to determine an order, though Calvin uses batching to improve throughput at further latency cost. Most recent work in this space, Google's Spanner, relies on tight clock synchronization to determine when an operation is safe to commit. While these systems are well-suited for the particular domains they were designed, a completely asynchronous, low-latency transaction management protocol, in line with the fully distributed NoSQL architecture is desired.

Thus, there is a need for a new approach to determining the order of interdependent operations including the management of dependencies in a distributed system, and further, that allows for efficient implementation on top of existing NoSQL storage systems to support multi-key transactions.

### SUMMARY OF THE INVENTION

The invention is directed to an efficient event-ordering service as well as a simplified approach to transaction processing based on global event ordering.

More specifically, the invention is directed to managing dependencies between operations in a distributed system. According to the invention, a fault-tolerant event ordering service externalizes the task of tracking dependencies from distributed subsystems to capture a global view of dependencies between a set of distributed operations. Specifically, the invention enables multiple independent subsystems to share and maintain a unified directed acyclic graph that keeps track of happens-before relationships at fine granularity.

The invention maintains an explicit event dependency graph between operations carried out by the distributed system to enable the system to determine when operations may conflict, as well as help assign an advantageous order of execution to events. Happens-before relationships are factored out of components that comprise the system and are centralized in a separate event ordering service. This not only simplifies implementation of individual components by freeing them from having to propagate dependence information, but also enables dependence relationships to be maintained even through operations that span multiple independent systems. The graph representation captures ordering relationships at much finer granularity than both Lamport timestamps and vector clocks. The invention also enables applications to query the graph and determine if two events are concurrent, which in turn identifies those instances where the application can make its own decision, typically as late as possible, on how to order these concurrent events optimally.

According to the invention, event ordering is factored out of independent subsystems into a shared component that tracks timing dependencies between actions that traverse multiple subsystems. Dependencies are tracked at very fine granularity by maintaining a full event dependency graph. This yields expressive systems that can distinguish and take advantage of concurrency where available and a background mechanism ensures that the storage required for the system is always proportional to the number of in-progress events and their dependencies. Additionally, the invention supports late time-binding, which is picking an absolute order of events that is congruent with constraints as late as possible. Late assignment of time order provides extensive freedom to applications on how to schedule a set of concurrent events whose time order is under-constrained.

While the invention is of general utility to any kind of distributed system, it is of crucial importance in data stores to assign an order to concurrent transactions in a scalable, distributed key-value store such that the system can provide a strong consistency guarantee.

Furthermore, the invention adds serializable multi-key transactions to horizontally scalable NoSQL data stores. NoSQL data stores span multiple hosts and share their data across many machines in order to scale horizontally. Specifically, the invention can transform a horizontally sharded NoSQL store—such as the HyperDex-v0.2 data store—to support transactions that span multiple keys. The resulting system provides a consistent, fault-tolerant data store with fully serializable transactional semantics.

The invention greatly simplifies the construction of distributed systems by not only freeing each subsystem from having to implement, maintain and propagate meta-data related to time ordering, but also to enable disparate subsystems to relate and order their internal events. Of course, the critical parts of each subsystem that determine dependence relationships are application-specific and cannot be factored out into a generic component. However, the invention eliminates the need for code which explicitly propagates this information throughout the system. Omitting such information from network packets simplifies the format and speeds up applications by itself. Critically, the fine grain dependence information encapsulated in the event dependency graph can be used to pick an event order as late as possible, enabling the system to take advantage of concurrent activities whenever possible.

The service according to the invention takes an entirely different approach than timestamp-based systems in how it captures causality. It creates an explicit event dependency graph to track causality relationships and offers fine grain control to the application in determining what events get captured and how events are ordered. Furthermore, by externalizing event-dependency handling and management and providing a unifying application programming interface (API), the invention simplifies event-ordering management for applications and enables dependency tracking for events that span application boundaries.

The service according to the invention maintains event ordering in one location accessible to all members of a system and, in effect, maintains consensus on the happens-before order between events. Applications avoid a dependency upon communication-intensive protocols like Paxos and Causal multicast, or failure-sensitive multi-phase commit protocols.

Furthermore, the invention externalizes event ordering. Externalizing event ordering to the service of the invention eliminates redundancy and also enables causal consistency guarantees that span multiple applications.

The service according to the invention prevents dependency cycles and is not limited to HyperDex, and furthermore, may be used to create transactions on other NoSQL systems. The service answers questions about event order, and exposes simple and efficient operations.

Furthermore, the invention is directed to a NoSQL system that provides support for efficient, one-copy serializable ACID transactions by combining optimistic client-side execution with a novel server-side commit protocol referred to herein as “linear transactions”. In line with the NoSQL design philosophy, linear transactions involve solely those servers that hold the data affected by a transaction, and eliminate the need for transaction managers and clock synchrony. The coordination among these servers is performed by a modified single-pass chaining protocol that is fault-tolerant, non-blocking, and serializable.

Three techniques, working in concert, shape the design of linear transactions and account for its advantages. First, linear transactions arrange the servers in dynamically-determined chains, where transaction processing is performed in an efficient two-way pipeline. Traditional consensus protocols, such as Paxos and Zab, require a designated server to perform a broadcast followed by a quorum-incast, which divides overall throughput by the number of servers involved. In contrast, each server involved in a linear transaction can pump messages through the pipeline at line rate.

Second, linear transactions further reduce transaction overheads by not explicitly ordering concurrent but independent operations with respect to each other. Traditional approaches to transaction management compute a total order on all transactions, which necessitates costly global coordination. Such over-synchronization is a significant source of inefficiency, which some systems target by partitioning the consensus groups into smaller units. In contrast, linear transactions leave unordered the operations belonging to disjoint, independent transactions. This enables the servers to execute these operations in natural arrival order, saving synchronization and ordering overhead, without leading to any client observable violations of one-copy serializability. Linear transactions determine a partial order between all pairs of overlapping transactions that have data items in common, and also detect and order transitively interfering transactions, thereby ensuring that the global timeline is always well-behaved.

Finally, linear transactions improve performance by taking advantage of the natural ordering imposed by the underlying data store. Specifically, they avoid computing a partial order between old transactions whose effects are completely reflected in the data store, and new transactions that cannot have observed any state of the system prior to fully committed transactions. Traditional approaches, especially those that involve Paxos state machines, would require the assignment of an explicit time slot, and perhaps couple it with garbage collection. In contrast, linear transactions can avoid these overheads because the happens-before relationship is inherently reflected in the state of the store and no reordering can lead to a consistency violation.

It is impossible to achieve ACID guarantees without a consensus protocol or synchronicity assumptions, and linear transactions are no exception. The invention relies on a replicated state machine called a coordinator to establish the membership of the servers in the cluster, as well as the mapping of key ranges to servers. A crucial distinction from past work that invoked consensus on the data path, however, is that linear transactions involve this heavy-weight consensus component only in response to failures.

The invention includes a linear transactions protocol for providing efficient, one-copy serializable transactions on a distributed, sharded data store. The protocol can withstand up to a user-specified threshold of faults, guarantees atomicity and provides isolation. The protocol is an asynchronous, fault-tolerant, fully distributed key-value store that supports multi-key transactions without a shared consensus component on the data path and represents a new design point in the continuum between NoSQL systems and traditional RDBMSs.

The invention and its attributes and advantages may be further understood and appreciated with reference to the detailed description below of contemplated embodiments, taken in conjunction with the accompanying drawing.

### DESCRIPTION OF THE DRAWING

The accompanying drawings, which are incorporated in and constitute a part of this specification, illustrate an implementation of the invention and, together with the description, serve to explain the advantages and principles of the invention:

FIG. 1 illustrates an exemplary distributed system according to the invention.

FIG. 2 illustrates a more detailed block diagram of a client node illustrated in FIG. 1.

FIG. 3 illustrates one embodiment of a construction of a dependency graph according to the invention.

FIG. 4 illustrates one embodiment of a creation of a dependency graph according to the invention.

FIG. 5 illustrates one embodiment of an application programming interface (API) according to the invention.

FIG. 6 illustrates one embodiment of a set data structure used to track visited vertices according to the invention.

FIG. 7 illustrates one embodiment of five transactions that operate on three different keys according to the invention.

FIG. 8 illustrates one embodiment of a system architecture for implementation of a linear transactions protocol according to the invention.

FIG. 9 illustrates one embodiment of an application programming interface (API) according to the invention.

FIG. 10 illustrates one embodiment of a system architecture including disjoint transactions according to the invention.

FIG. 11 illustrates one embodiment of a system architecture including overlapping transactions according to the invention.

FIG. 12 illustrates one embodiment of a dependency cycle according to the invention.

FIG. 13 illustrates one embodiment of linear transactions capturing dependences between transactions according to the invention.

FIG. 14 illustrates one embodiment of fault tolerance achieved through replication according to the invention.

### DETAILED DESCRIPTION OF THE INVENTION

As workloads on modern computer systems become larger and more varied, more and more computational resources are needed. For example, a request from a client to web site may involve one or more load balancers, web servers, databases, application servers, etc. Any such collection of resources tied together by a data network may be referred to as a distributed system. A distributed system may be a set of identical or non-identical client nodes connected together by a local area network. Alternatively, the client nodes may be geographically scattered and connected by the Internet, or a heterogeneous mix of computers, each providing one or more different resources. Each client node may have a distinct operating system and be running a different set of applications.

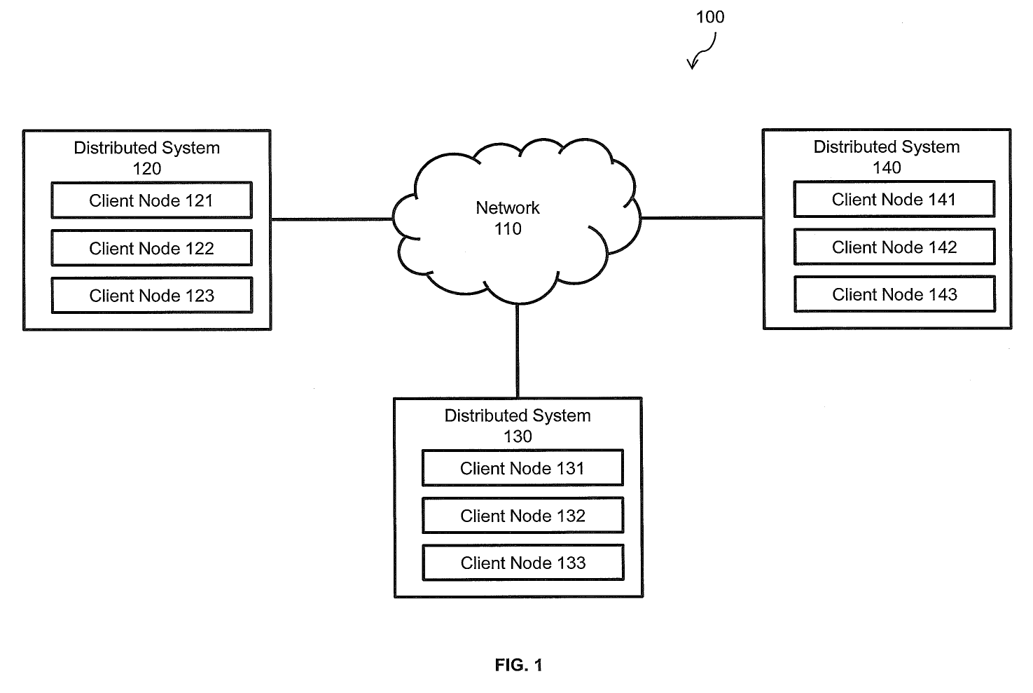

FIG. 1 illustrates an exemplary distributed system 100 according to the invention. A network 110 interconnects one or more distributed systems 120, 130, 140. Each distributed system includes one or more client nodes. For example, distributed system 120 includes client nodes 121, 122, 123; distributed system 130 includes client nodes 131, 132, 133; and distributed system 140 includes client nodes 141, 142, 143. Although each distributed system is illustrated with three client nodes, one skilled in the art will appreciate that the exemplary distributed system 100 may include any number of client nodes.

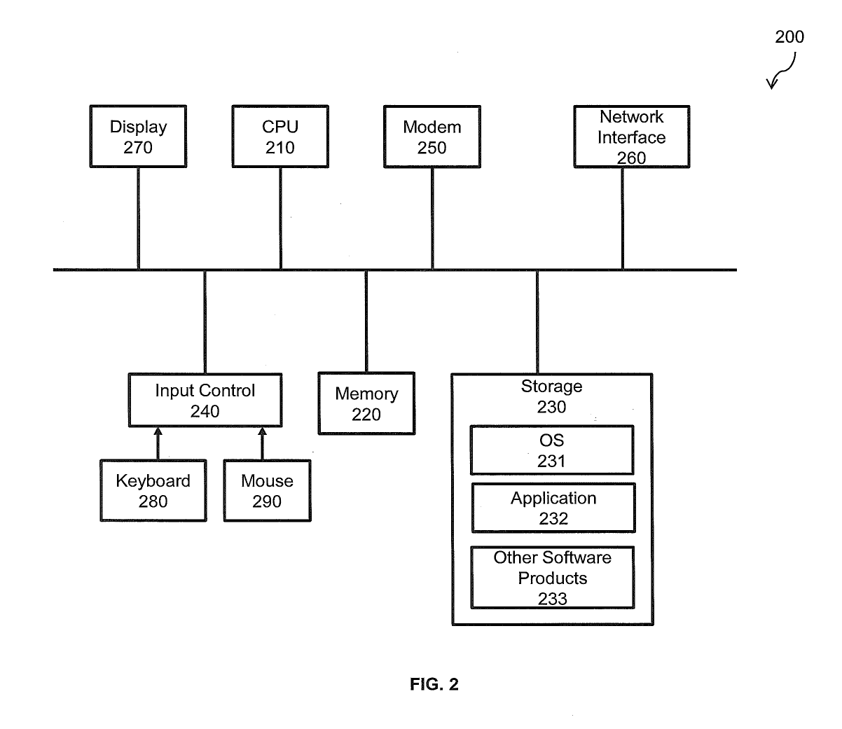

FIG. 2 is an exemplary client node in the form of an electronic device 200 suitable for practicing the illustrative embodiment of the invention, which may provide a computing environment. One of ordinary skill in the art will appreciate that the electronic device 200 is intended to be illustrative and not limiting of the invention. The electronic device 200 may take many forms, including but not limited to a workstation, server, network computer, Internet appliance, mobile device, a pager, a tablet computer, and the like.

The electronic device 200 may include a Central Processing Unit (CPU) 210 or central control unit, a memory device 220, storage system 230, an input control 240, a network interface device 260, a modem 250, a display 270, etc. The input control 240 may interface with a keyboard 280, a mouse 290, as well as with other input devices. The electronic device 200 may receive through the input control 240 input data necessary for creating a job (tasks) in the computing environment. The network interface device 260 and the modem 250 enable an electronic device to communicate with other electronic devices through one or more communication networks, such as Internet, intranet, LAN (Local Area Network), WAN (Wide Area Network) and MAN (Metropolitan Area Network). The communication networks support the distributed execution of the job.

The CPU 210 controls each component of the electronic device 200 to provide the computing environment. The memory 220 fetches from the storage 230 and provides to the CPU 210 code that needs to be accessed by the CPU 210 to operate the electronic device 200 and to run the computing environment. The storage 230 usually contains software tools for applications. The storage 230 includes, in particular, code for the operating system (OS) 231 of the device 200, code for applications 232 running on the system, such as applications for providing the computing environment, and other software products 233, such as those licensed for use with or in the device 200.

The invention is a standalone shared service that tracks dependencies and provides time ordering for distributed applications. The central schedulable entity is an event—an application-determined atomic operation that takes place on a single node—associated with a unique identifier. An event may be as fine-grained as the execution of a single instruction or a basic block, though in practice, applications create events that correspond to indivisible actions they take internally in response to inputs. For instance, a simple networked disk may create a “READBLOCK” event to correspond to the handling of a read request. A more complex file server may create multiple events (e.g. “CHECK CACHE,” “READ INODE”, etc.), each dependent on a subset of others, that correspond to the separate steps involved in serving a file request. The service leaves the precise semantics associated with events up to applications to determine, while keeping track of the partial order between events.

Internally, the service according to the invention builds and maintains an event dependency graph, a directed acyclic graph whose vertices correspond to events and whose edges correspond to happens-before relationships. For purposes of this application, the term “dependency” and the term “happens-before relationship” are used interchangeably herein. The term “causal relationship” is related, but more specific and not synonymous with the terms “dependency” and “happens-before relationship”; a happens-before relationship can emerge without a causal relationship. This edge therefore represents, in one place, all the ordering related constraints that span operations across multiple applications.

The central task of the service, then, is to enable applications to create and maintain a coherent event dependency graph. A dependency graph is coherent if it contains no time violations; that is, it is free of cycles. The invention provides interfaces by which applications create events, query the relationship between two events to help applications determine a coherent event ordering, and atomically establish sets of new happens-before relationships between events.

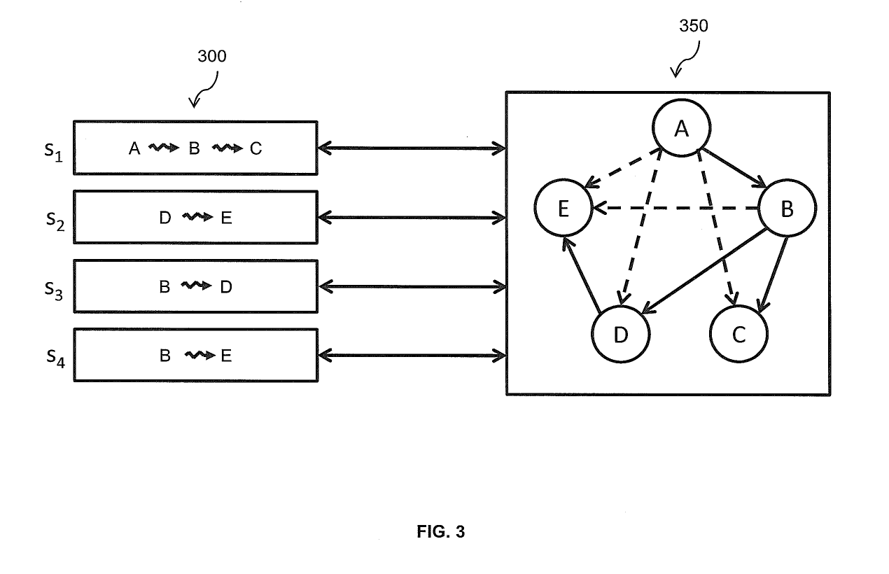

FIG. 3 illustrates one embodiment of a construction of a dependency graph. In the embodiment described, the dependency graph uses an example system 300 consisting of four subsystems—s₁, s₂, s₃, s₄—and five operations—A, B, C, D, E. In this example, the independent subsystems s₁, s₂, s₃, s₄ each handle a different subset of events and each subsystem specifies some ordering between operations to the fault-tolerant event ordering service. For example, s₂ specifies that for any thread of execution, operation D should happen before operation E, as denoted by the [symbol] symbol. If one of the subsystems of the system 300 submits a dependency that would create a cycle, the fault-tolerant event ordering service would reject the submission and send a notification.

Specifically, the fault-tolerant event ordering service maintains an event dependency graph 350, ensuring that the happens-before relationship on each service is consistent with the global happens-before relationship. In the event dependency graph 350, solid edges graph indicate explicitly created happens-before dependencies, while dashed edges indicate transitively-computed dependencies which are not actually instantiated.

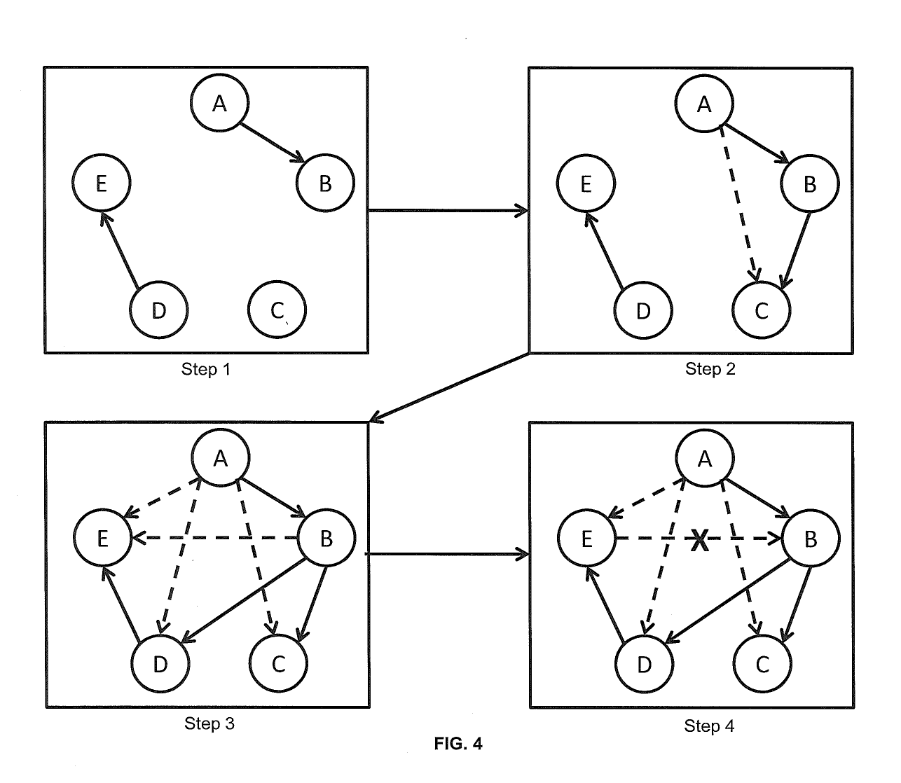

FIG. 4 illustrates the step-by-step creation of the dependency graph including both the explicit edges and the transitively-deduced edges, and shows how the fault-tolerant event ordering service prohibits the addition of E [symbol] B. As dependencies are added between events, edges are added to the event dependency graph. In Step 1, Step 2, and Step 3, the application adds dependencies between events, imposing order on them. As shown in FIG. 4, in Step 4, the fault-tolerant event ordering service prohibits the dependency E [symbol] B because the event dependency graph already has a path between B and E implying that B [symbol] E.

In addition to tracking dependencies, the fault-tolerant event ordering service can use the event dependency graph to answer queries regarding the ordering between two operations. Two events can be concurrent, that is, there is no directed path between the two in the event dependency graph, or one of them precedes the other. The existence of a directed path between two components implies that the fault-tolerant event ordering service has made a series of commitments that forces one event to necessarily succeed the other. Since any rearrangement of events that violates a happens-before relationship would implicitly violate an assumption established earlier, the query functionality enables subsystems to discover and obey any such constraints. Further, queries can help applications identify opportunities for concurrency and discover when they can safely rearrange the timeline ordering of events to safely achieve higher performance.

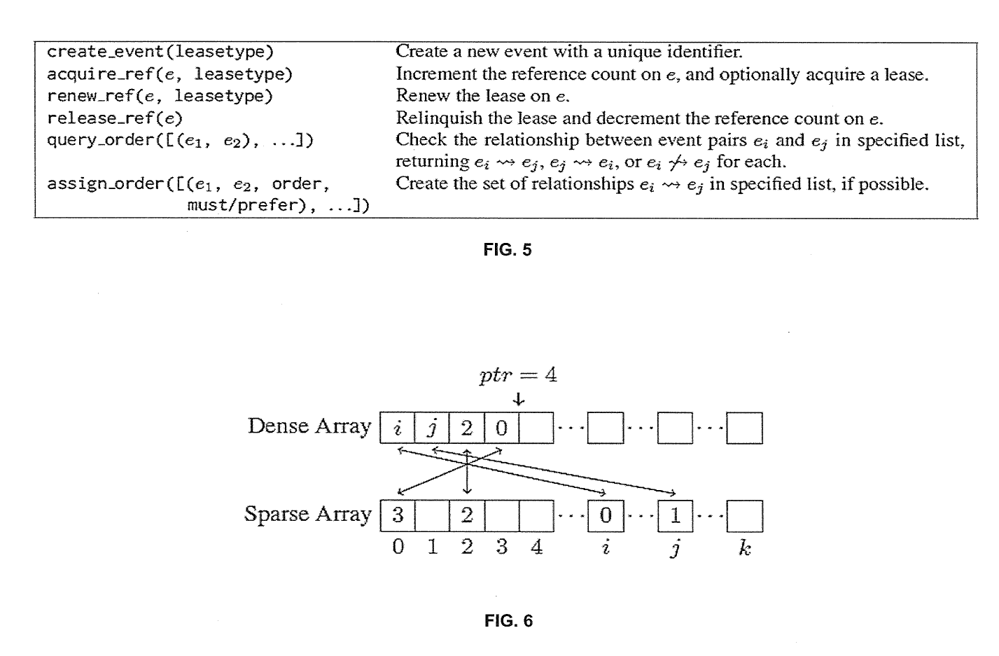

Application subsystems interact with the fault-tolerant event ordering service through a simple application programming interface (API) as shown in FIG. 5. The API is designed around the event and dependency abstractions. The API enables an application to manipulate, extend and query the event dependency graph. The API calls or data communication protocols can be batched, which enable an application to group several calls into one round-trip to the fault-tolerant event ordering service. More specifically, applications manipulate dependencies with query_order and assign_order calls. Events are garbage collected using the reference counting calls.

Applications can add new events to the event dependency graph with the create_event call, which creates a new vertex and returns a globally unique identifier. This identifier can be used in subsequent calls to query the graph and to establish happens-before relationships between vertices. Applications can add happens-before relationships between events by calling assign_order. The fault-tolerant event ordering service operation is executed atomically and supports adding multiple edges between any collection of event pairs.

The atomicity guarantees support safe yet concurrent use of the fault-tolerant event ordering service without recourse to an external lock service. The arguments to assign_order are a collection of event pairs to be ordered, a bit per pair indicating how the application would like to order these two events (namely, happens-before or happens-after), and a bit per pair indicating whether the requested order is a “must” or “prefer”.

A “must” ordering conveys a hard constraint from the application that the two events need to be ordered in the requested way; if a must request cannot be satisfied, the fault-tolerant event ordering service aborts the entire assign_order request without any side effects and returns an error to the application. In contrast, a “prefer” ordering is an indication from the application that it would prefer a particular ordering between two events specified in the request, but if previously established constraints make this impossible, it is willing to accept a reversal. The multi-key transactional store makes extensive use of preferred orderings in order to avoid having to reorder events from their order of arrival and appearance in internal logs.

One feature of the fault-tolerant event ordering service is to quickly determine whether a set of requested order assignments leads to a coherent timeline. It does so by going through the requested happens-before relationships in an assign_order call, and determining the preexisting constraints between each event pair u, v. If the pre-existing constraints in the graph are coherent with a “must” or “prefer” request, the service moves onto the next event pair. If they are not, it reverses a prefer request and notes the reversal for the client, while a violation of a “must” request leads to an abort of the transaction.

Determining pre-existing constraints is a potentially costly operation involving cycle detection, whose latency can be O(|V|) where |V| is the number of outstanding events in the system. In order to determine the relationship between two events u, v, the fault-tolerant event ordering service must find a path u→v, or v→u, or show that no such path exists. To do this, a standard breadth-first search (BFS) is performed to discover the relationship between u and v. Since a naive BFS would either require Ω(|V|) operations to initialize a visited bit field in every vertex or else dynamically allocate memory, and since |V| can be large, the services employs a fast BFS algorithm whose running time is proportional to the number of vertices traversed. Specifically, the system pre-allocates all memory required for graph traversal at the time of vertex creation by creating two arrays, dense and sparse, of size |V|. A pointer “ptr” is initially set to 0. When BFS visits a node i for the first time, sparse[i] is set to “ptr”, dense[ptr] is set to i and increments “ptr”.

FIG. 6 illustrates one embodiment of a set data structure used to track visited vertices according to the invention. Checking to see if a node i has been visited can then be accomplished by checking if sparse[i]<ptr and “dense[sparse[i]]==i. Thus, a vertex i is in the set if and only if both conditions are met. Adding an element to the set is done with sparse[i]=ptr; dense[ptr++]=i. Clearing the set is done in constant time by setting ptr=0. This optimization enables the core traversal algorithm to require no memory allocation and only a single cache line worth of initialization.

Careful attention is paid to the cost of creating new events and happens-before relationships. Event creation is a constant time operation and corresponds to creating a new vertex in the event dependency graph as well as reallocating the dense and sparse arrays. Because the arrays are guaranteed not to be in use during event creation, they can be reallocated in O(1) time without preserving their contents. Internally, free-lists aggressively reuse memory to ensure that memory usage stays proportional to the size of the event dependency graph. Similarly, happens-before relationship creation is efficient both in time and space, where the dominant cost is that of cycle detection.

Two explicit design decisions render the invention practical, safe and fast. First, an operation to remove a happens-before relationship is purposefully not provided. This ensures that an event ordering decision, once established, is inviolable. Applications can safely commit to a particular time order once it is committed to, as subsequent operations can only further constrain, but never violate, any established dependency. This enables clients to be able to issue side-effects and produce user-visible output based on responses. Removing a happens-before relationship would allow applications to reverse course and could lead an application to violate ordering constraints.

Second, the services does not attempt to discover the minimal set of prefer reversals to render a suggested assign order request coherent with respect to the existing event dependency graph. Computing such a set is NP-complete. Instead, the service first applies all “must” edges before “prefer” edges, thereby ensuring that a “prefer” edge is never established ahead of a “must” and thus will never cause an order assignment to abort when it could have been satisfied. Once all “must” edges are satisfied, the “prefer” edges are applied in the order specified by the application. It is further contemplated that an application can have some degree of control over which prefer edges are prioritized through the order in which they appear in the assign_order request. This concession avoids an NP-complete problem while providing a degree of control.

In order to provide systems with some flexibility in how operations are ordered, the service according to the invention enables an application to discover the hard constraints in the underlying event dependency graph with the query_order call. Query_order takes a list of event pairs, and returns a list of <, >, and ? to indicate that the events precede, succeed, or are concurrent with each other, respectively. The query_order call can be used to determine whether a particular ordering of events would yield a timeline violation or to reorder events to achieve higher concurrency and performance. This determination is performed atomically and provides a response guaranteed to be correct at the time of, but not necessarily subsequent to, its creation. Since the fault-tolerant event ordering service exercises no control over a distributed system, an application wishing to count on the results of a query_order remaining valid after the call needs to use application-specific mechanisms to synchronize with other components that might mutate relevant regions of the event dependency graph.

The event dependency graph according to the invention grows without bound as long as a distributed system is active. Garbage collection is employed to keep the size of the graph proportional to the number of ongoing, live events in the system. A critical invariant that the service needs to maintain is that all events that could be submitted as arguments to any of the API calls remain within the graph, since they may be used as starting points in BFS operations; this is accomplished by associating a reference count with each event. Event handles are acquired through an acquire_ref call, which increments a reference count. An argument to this call specifies how the reference count is managed. An “ephemeral” acquire is tied to the associated TCP connection, and is automatically released if the TCP connection fails. A “timed” acquire establishes a lease that is automatically released after a client-specified period of time unless renewed with a “renew_ref” call. And a “manual” acquire indicates that the application is responsible for explicitly decrementing the reference count with a “release_ref” call at a later time. “ephemeral” is convenient for application developers, while manual and timed enable events to persist and retain previously established ordering constraints through subsystem failures. Overall, this reference counting mechanism ensures that all events that can be named by clients are pinned in memory, which simplifies cleanup of expired state in the event dependency graph.

The service automatically eliminates unneeded events by traversing the event dependency graph and eliding nodes whose reference counts have reached zero. Garbage collection is strict: the traversal is initiated by “release_ref” operations that reach a zero reference count and proceed by decrementing the reference counts on all events that directly succeed that event. If the reference counts on further events also reach zero, the process continues transitively, eliminating older events whose existence cannot matter to future event ordering decisions. Because no path may exist from any active event to another whose reference count has reached zero, garbage collection cannot cause a potential cycle in the event dependency graph to be missed.

The service according to the invention provides fault tolerance by replicating its internal state, that is, its event dependency graph, to several different physical nodes. Since consistency of the event dependency graph is critical to providing correct event ordering, the service replicates its state using chain replication, which provides strong consistency. The exact number of replicas in the chain is a deployment specific decision and reflects the maximum number of simultaneous faults the system is likely to experience. The current design assumes a fail-stop model, although it is possible to alter the design to also tolerate crash failures.

With the event dependency graph being the only persistent state, the invention therefore offers the same fault tolerance guarantees as chain replication. With f+1 replicas, the fault-tolerant event ordering service can handle f faults. In response to a replica failure, the service according to the invention notifies an external coordination service, built on Paxos replication, to reconfigure the chain and propagate the new epoch and configuration to the chain members. Clients, or nodes, acquire the new chain head and tail through DNS; epoch numbers embedded in the protocol ensure that nodes can discard out-of-date messages. This replica failure recovery procedure follows exactly from the standard chain replication protocol. A similarly fault-tolerant coordination and configuration service can be built using other consensus infrastructure, such as Chubby or Zookeeper.

The approach to event-ordering according to the invention differs fundamentally from previous event-ordering techniques based on logical clocks, such as Lamport and Vector timestamps. There are three key differences between the invention and timestamp-based approaches. First, existing timestamp-based approaches assume that each application track its own events and manages its own event-ordering. However, modern application ecosystems have complex interactions between applications that were not originally designed to work together. Event-ordering dependencies cross application boundaries, but without a unifying API, there is no simple way to enforce these dependencies. Second, tying event ordering to the sending and receiving of messages can create causal relationships that are irrelevant to the correctness of the application. For example, requests processed by the same server may become causally related and cause otherwise concurrent operations to have to execute in timestamp order. Logical and vector clocks sacrifice fine-granularity to be cheap and compact. In contrast, the applications require a Remote Procedure Call (RPC) to a separate server, but provide fine-granularity and late time binding. Lastly, detecting dependency violations are performed independently and detection hinges on communication between the participants. The example dependency violation in FIG. 4 would only be detected using timestamp-based approaches if the timestamps assign order between events generated by operation E and B. This requires that these subsystems communicate directly, even if, for example, operation E and B are both writing to a shared data store and would not otherwise need to communicate. With the service of the invention, the data store could instead enforce the ordering dependency.

To satisfy the need for transactions in a NoSQL storage system, a new distributed transaction protocol that relies on globally consistent event ordering is provided to significantly reduce coordination overhead and improve the performance of a certain class of transactions. Transactional chaining is a highly efficient transaction processing protocol for providing multi-key transactions. According to the protocol, each transaction is processed along a chain of servers. Members of the chain cooperate to determine the order in which the transaction must commit relative to concurrent transactions. Chain members use the fault-tolerant event ordering service to ensure that local decisions are consistent with some global serializable ordering of the transactions.

The members of a transactional chain are servers that are responsible for the keys specified in a multi-key transaction. Transactional chaining therefore guarantees that two concurrent transactions with operations that reference the same key will necessarily share a server in their transactional chain. Furthermore, a server's position in the chain is arranged according to a well-defined order. This ensures that every transactional chain is a subsequence of the unique ordered sequence consisting of all servers. More importantly, concurrent transactions that share multiple keys, and therefore multiple servers, access the shared servers in the same order.

Given this chain construction, the execution of a transaction resembles a two-phase commit by having two distinct phases, with the first sending messages down the chain, and the second sending messages back up the chain. In the first phase, transactional chaining sends a “prepare” message down the chain to determine if the operations in the transaction can commit. Any server along the chain may unilaterally abort the transaction by sending an “abort” message back up the chain rather than propagating the “prepare” message, which ends the first phase and begins the second phase. The second phase also begins upon the arrival of the “prepare” message at the end-node, and a “commit” message is sent back up the chain. Crucially, no data is altered at the “prepare” stage; instead, a successful “prepare” message merely indicates that the server may commit the prepared transaction regardless of the order in which concurrent transactions commit. The actual commit order is determined on the commit path back up the chain in order to maximize the effects of late time-binding in the service.

Each node in a transactional chain must maintain the invariant that a prepared transaction may be able to commit in any order with respect to other concurrently prepared transactions. This invariant ensures that any transaction that has been prepared at all servers in a chain will commit at all servers as well. Transactions which consist solely of “get” and “put” operations may always read or overwrite the latest value of a key at commit time. Because no data is altered until a transaction commits, “get” and “put” operations can always read or overwrite the most recently committed state at commit time. In order to prepare a transaction with conditional operations, a server must ensure that the conditional component is true for the most recently committed state, and that concurrently prepared transactions will not alter the outcome of the conditional component. Once prepared, the server maintains the invariant by aborting transactions which may change the outcome of the conditional component.

Members in a transactional chain cooperate to ensure that the transaction commits in the same order on all nodes with respect to other transactions. During the prepare stage of a transaction, members in its chain capture information about other concurrent transactions which share one or more keys. Each server, when preparing transaction tₓ, checks for all concurrent transactions t_{c} which have keys in common with tₓ. For each t_{c}, a server makes an annotation in its local state that tₓ and t_{c} need to be ordered with respect to each other. It also embeds metadata for t_{c} into the “prepare” message for future members in the chain which contains the event id for t_{c} and indicates which member of the chain (the dictator) is responsible for ordering tₓ and t_{c}. When a server receives a “commit” message for tₓ, it queries the service according to the invention for a happens-before relationship between tₓ and every t_{c} which has been noted in the local state. If the fault-tolerant event ordering service returns a relationship, t_{c′} [symbol] tₓ, then tₓ is postponed until t_{c′} commits or aborts at which point the server reevaluates its ability to commit tₓ. If, instead, the service returns ∀t_{c}, tₓ [symbol] t_{c}, then tₓ happens before every other transaction prepared on the server because no other concurrent transaction could precede tₓ (otherwise it would be in the local state for tₓ). When a transaction reaches this point, the server assumes the role of dictator, and inspects the metadata from the “prepare” message for tₓ.

For each transaction tₘ in the metadata for which the server is a dictator, the server makes an assign_order call to the service, preferring to order tₓ [symbol] tₘ. As with dependencies captured in the local state, if the service orders tₘ [symbol] tₓ, tₓ is delayed until tₘ commits or aborts, and the server re-evaluates tₓ. Once a transaction is ordered with respect to all t_{c} and tₘ, the dictator makes a final assign order call to place tₓ after every prior transaction which operated on the same keys as tₓ. It should be noted that dependencies are captured at the finest granularity possible to preserve dependencies between transactions.

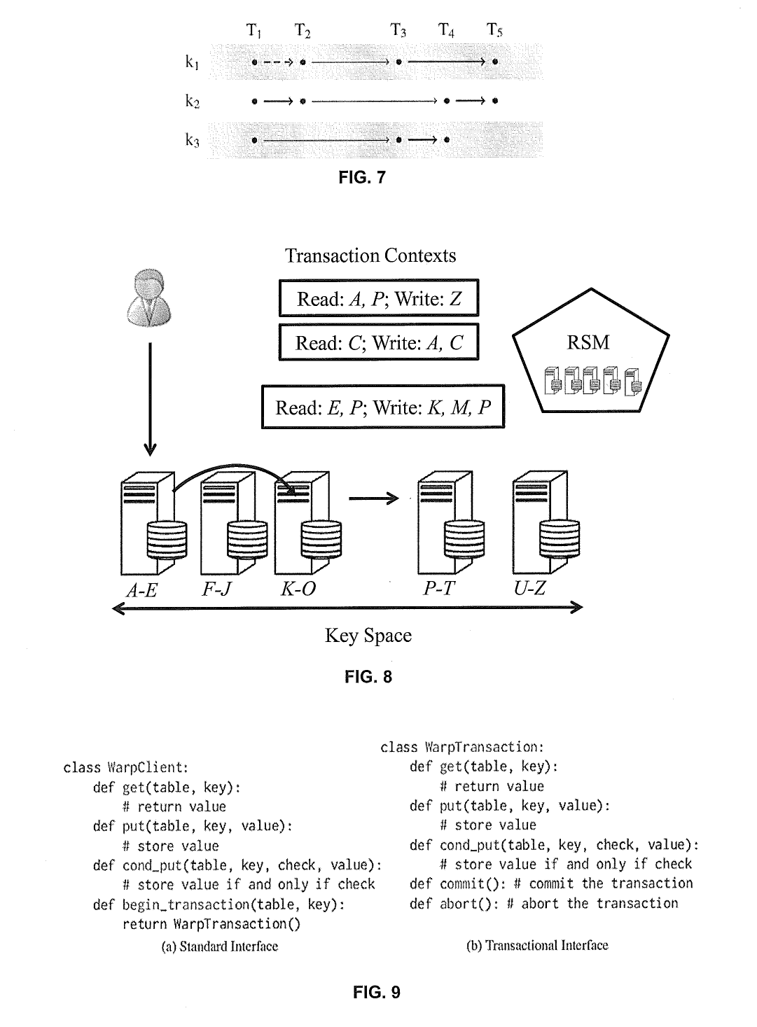

FIG. 7 illustrates an example with five transactions that operate on three different keys. Solid, thick arrows indicate happens-before order assigned by the dictator, while dashed arrows indicate concurrent transactions which are applied using the order retrieved from the fault-tolerant event ordering service. Thin arrows indicate dependencies upon committed data. It should be noted that the service never permits a cycle to occur.

A set of transactions is serializable if it is equivalent to some execution of the system in which the same transactions are applied sequentially without any interleaving. Transactional chains always apply transactions in a serializable manner. According to the invention, a transaction is always committed locally as an atomic group. Thus, it is impossible for a single transaction to generate a conflict and the cycle is formed by interactions between two or more transactions. The protocol ensures that any transactions that are concurrently prepared are ordered using the service according to the invention and that all possible dependencies are captured. The invention necessarily orders the transactions in a manner that prohibits cycles. It follows that the cycle cannot exist, and therefore a non-serializable schedule cannot be created by an execution of transactional chains. The linear transactions protocol according to the invention builds on top of a linearizable NoSQL store while keeping the core architecture of the system relatively unchanged by integrating the transaction processing directly into the storage servers rather than introducing additional components dedicated to processing transactions.

The system comprises three components. The first and primary component is a data storage server. Each data server is responsible for a subset of keys in the system, generally chosen using consistent hashing. Collectively, the storage servers hold all the data stored in the system. The data is sharded across servers so that each server is responsible for a fraction of the systems' data. While each data server is f+1 replicated to provide fault-tolerance for node failures and partitions that affect less than a user-defined threshold of faults, for simplicity, each data server is treated as a singular entity. In addition, it is assumed that all clients issue solely read and write operations and not complex operations.

A second logical component called a coordinator partitions the key space across all data servers, ensuring balanced key distribution and facilitating membership changes as servers leave and join the cluster. Since the coordinator is not on the data path, its implementation is not critical for the operation of linear transactions. Many NoSQL systems centralize this functionality at a single operations console, backed by a human administrator; the invention, however, relies on a replicated state machine that maintains the set of live hosts, the key partitioning table and an epoch identifier in a replicated, fault-tolerant object known as a mapping.

The third class of components, the clients, issue requests to the data servers with the aid of this mapping. Since the mapping is pushed to all non-disconnected servers by the coordinator after every configuration change, and since every client request and server response carries the epoch id, out of date clients and servers can be detected and directed to re-fetch the mapping when necessary.

With the general operation of linear transactions, clients issue operations, both directly to the data store, and indirectly within the context of a transaction. Non-transactional requests identify the object to store or retrieve using a single key, and immediately perform the request against the relevant back-end storage server. Alternatively, a client may begin a transaction, which creates a transaction context, and issue several operations within the context of the transaction. Operations executed within the transaction do not take place on the servers immediately. Instead, the client library logs the key and type of each access. For a read, the client retrieves the requested data from the storage servers, and records the value it read in a cache kept within the transaction context. Subsequent reads within that transaction are satisfied from this cache, providing read isolation. For a write, the client stores all modifications locally within the transaction context without contacting any storage server. Multiple writes to the same key overwrite the stored modifications table. At commit time, the client library submits the set of all read keys, their read values and all modified unique key value pairs to the storage servers as a single entity, known as a linear transaction. The data servers, collectively, only commit the modifications if none of the values read within the transaction context have been modified while the transaction was being processed.

FIG. 8 illustrates an overall system architecture in which data is sharded across five storage servers. The replicated state machine (RSM) locally maintains metastate about cluster membership and the mapping from keys to servers. Each server is assigned partitions of the key-space by the RSM and fetches a copy of the mapping as well as maintains contact with the RSM to be notified of updates. A client may perform transactions by directly contacting the storage servers. Specifically, clients communicate with the linear transactions protocol through a client library, which transparently retrieves the mapping from the RSM, maintains a cached copy of the mapping, and contacts the storage servers to issue operations. The arrows indicate the communication necessary for a linear transaction involving the indicated servers.

FIG. 9 illustrates one embodiment of an application programming interface (API) according to the invention that illustrates the core operations of the linear transactions protocol. The entire API permits a wide range of atomic operations that are separate from the API presented in FIG. 9. Specifically, FIG. 9(a) illustrates the standard interface and FIG. 9(b) illustrates the transactional interface. The non-transactional and transactional APIs intentionally present the same set of operations. Specifically, this API captures the essential components of the interface to the NoSQL store. While clients may issue “get”, “put”, and “del” primitives either directly to the data store, or within the context of a transaction, for simplicity of the protocol description, it is assume that all accesses are transactional and that each client has a single outstanding transaction. It is contemplated that clients may begin any number of transactions simultaneously, may mix transactional accesses with direct get/put operations on the data store, and may create nested transactions.

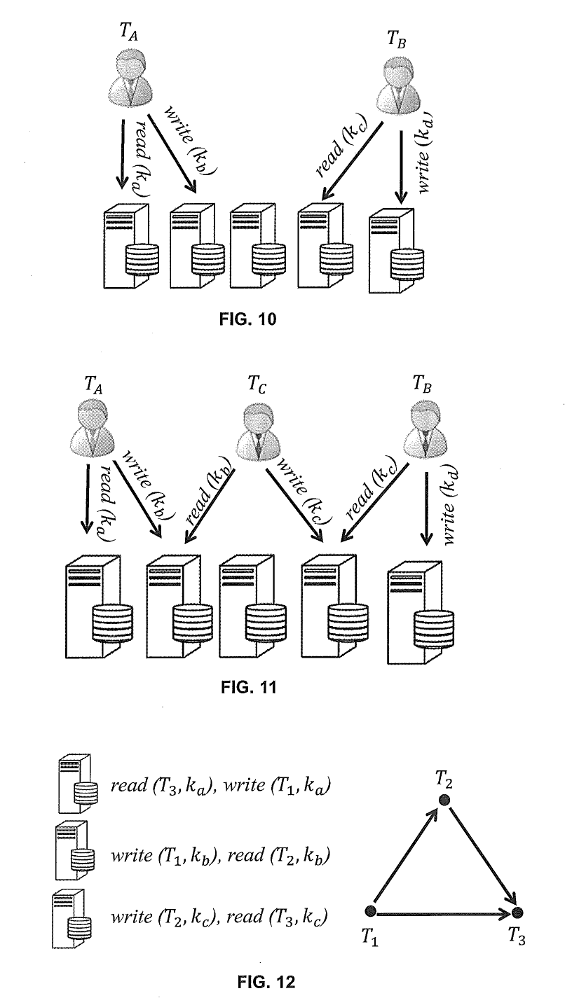

In order to provide one-copy serializability, the transaction management protocol identifies all required timing related constraints. In order to perform this, overlapping transactions are identified. Formally, a transaction T_{A} is said to overlap a transaction T_{B} if they have an object immediately in common, or if T_{B} appears in the transitive closure of T_{A}'s overlapping transactions. Non-overlapping transactions are said to be disjoint. Intuitively, identifying overlapping transactions is critical for consistency because all of the operations involved in two overlapping transactions need to be ordered with respect to each other to ensure atomicity and serializability. At the same time, identifying disjoint transactions is critical for performance, as they can proceed safely in parallel, without restriction. FIG. 10 and FIG. 11 respectively illustrate disjoint and overlapping transactions.

As shown in FIG. 10, operations performed within disjoint transactions may freely interleave without violating one-copy serializability because no matter what order the operations execute, the final state is, by definition, indistinguishable by clients. Had a client issued an operation (whether its own transaction or raw accesses directly against the key store) that could have distinguished between these states, that operation would cause the previously disjoint transactions to overlap, and thus would cause the protocol to enforce strict atomicity and ordering between them. Linear transactions leverage this observation by executing disjoint transactions without any coordination. As shown in FIG. 10, the clients read and write to entirely disjoint sets of keys.

As shown in FIG. 11, overlapping transactions require careful handling to ensure serializability. Specifically, transaction T₃ overlaps with T₁ and T₂ making all transactions overlap. If two transactions T_{A} and T_{B} overlap, all operations o_{A}εT_{A} need to be executed either strictly before, or strictly after, o_{B}εT_{B}. Implemented naively, such an ordering constraint may imply, in the worst case, establishing an ordering relationship between a newly submitted transaction and every previously committed transaction, yielding O(N) complexity for transaction processing. However, if all the reads operations in a transaction T_{B} have read state that is subsequent to all the write operations in T_{A}, then the two transactions are already implicitly ordered with respect to each other. It would be redundant and wasteful to spend additional cycles on ordering transactions whose execution times differ so much that one transaction's state is already reflected in the read set of a subsequent transaction.

The protocol, then, concerns itself with correctly identifying overlapping transactions, determining happens-before relationships only between those operations that need to be serialized with respect to each other, and enabling disjoint operations to proceed without coordination.

The linear transactions protocol operates by crafting a chain of servers to contact for each transaction such that the chain identifies all overlapping transactions and enables operations to be sequenced.

The chain for each linear transaction is uniquely determined by the keys accessed or modified within the transaction. The chain for a transaction is constructed by sorting a transaction's keys and mapping each key to a server using the consistent hashing of the underlying key-value store. For example, the canonical chain for a linear transaction that accessed (read, write or delete) keys kₐ and k_{b} is the two servers that hold the keys, in the order kₐ, k_{b}. The servers are always arranged according to the lexical order of their respective keys. If a server is responsible for multiple ranges of keys, then it occurs in multiple locations in the chain.

The next step in linear transactions is to process a transaction through its corresponding chain. This is performed in two phases: a forward pass determines overlapping transactions, establishes happens-before relationships, and validates previous reads, while a backward pass either passes through an abort or commit response. Much like two-phase commit, the first phase validates the transaction before the second phase commits the result; however, unlike two-phase commit, linear transactions enable multiple transactions operating on the same data to prepare concurrently, tolerate failures of the client as well as the servers, and involve no data servers other than the ones holding the data accessed in a transaction.

The primary task of the forward phase is to ensure that a transaction is safe to be committed; that is, the reads it performed during the transaction and used as the basis for the writes it issued, are still valid. When a client submits a transaction, it goes through its transaction context and issues a “condput” with the old value it read for each object in its read set, where the new value is blank if the transaction did not modify that object. The rest of its modifications are submitted as regular put operations. The conditional part of the “condput” is executed during the forward phase, and if any conditionals fail, the chain aborts and unrolls.

The second critical task in the forward phase is to check each transaction against all concurrent transactions; that is, transactions that have gone through their forward, but not yet their backward phase. If the transactions operate on separate keys, they are isolated and require no further consideration. Transactions that operate on the same keys may either be compatible, in the case of a read-read conflict, or conflicting, in the case of readwrite or write-write conflicts. Compatible transactions may be prepared concurrently. Of a pair of conflicting transactions, only one may ever commit. If a transaction conflicts with any concurrently prepared transaction, it must be aborted. On the other hand, if a transaction is compatible with or isolated from all concurrently prepared transactions, the server may prepare the transaction and forward the message to the next server in the chain.

Once a “prepare” message traverses the entire chain, the prepare phase completes and the commit phase begins. “Commit” messages traverse the chain in reverse, starting with the last server to prepare the transaction. Upon receipt of a “commit” message, each server locally applies writes affecting keys for which it is mapped to by the key-value store and passes the “commit” message backward to the previous server in the chain. While the description above outlines the basic operation of the chain mechanism, the protocol as described does not achieve serializability because the overview so far omitted the third crucial step where compatible transactions are ordered with respect to each other. FIG. 12 illustrates why ordering compatible, overlapping transactions is crucial with an example involving three transactions reading and modifying three keys held on three separate servers. If uncoordinated, these three servers may inconsistently apply the transactions, forming a dependency cycle between transactions. Under this hypothetical scenario, each server sees only two of the three transactions and only establishes one edge in the dependency graph with no knowledge of the other dependencies. To rectify this problem, compatible transactions must be applied in a globally consistent order that does not introduce dependency cycles. This is accomplished by linear transactions propagating dependency information in both phases.

As shown in FIG. 12, a dependency cycle between three transactions T₁-T₃ that read and write keys kₐ-k_{c}. If the three data servers were to commit data out-of-order, the transaction dependencies would yield the cycle shown on the right, violating serializability. Linear transactions permit only those dependencies that do not introduce a cycle.

Linear transactions prevent dependency cycles between transactions by collecting and propagating dependency information. This dependency information comes in two forms. First, happens-before relationships establish explicit serialization between two transactions. To say that T₁→T₂ is to say that T₁ happens-before T₂ and must be serialized in that order across all hosts. The second dependency type is a needs-ordering dependency that indicates that two transactions will necessarily have a happens-before relationship in the future, but cannot be ordered at the current point in time. Conceptually, the dependencies may be modeled on a graph, where directed edges indicate happens-before relationships and undirected edges indicate needs-ordering relationships that eventually become directed edges.

The linear transactions protocol captures all dependency information as transactions traverse chains in the forward and reverse direction. Dependencies accumulate and propagate in the same messages that carry the transactions themselves. This embedding ensures that, for each transaction, the dependency information will be immediately available to every successive node without additional messaging overhead.

Servers introduce happens before relationships as they encounter previously committed transactions that pertain to keys appearing in the current transaction. Conceptually, whenever a server introduces a happens-before relationship, it also embeds all transitive relationships—garbage collection limits the size of these sets. These implicit dependencies are added during both the forward and backward phases. Note that since all dependencies relate to compatible transactions, adding new dependencies during the backwards phase is a safe operation that cannot cause an abort.

Servers capture needs-ordering dependencies during the prepare phase of the transaction. For each concurrently prepared, compatible transaction, the server emits a needs-ordering dependency. The dependency specifies the two transactions and designates a server that [symbol] _{ω} must translate the needs-ordering dependency into a happens-before dependency. S_{ω} is chosen such that it is the server responsible for the last key in common to both transactions. This server sees the “commit” message first, as it is being propagated in the backward direction, and thus assigns the order to the two transactions. Every other server in common to the chains must commit in accordance with this server's selected ordering.

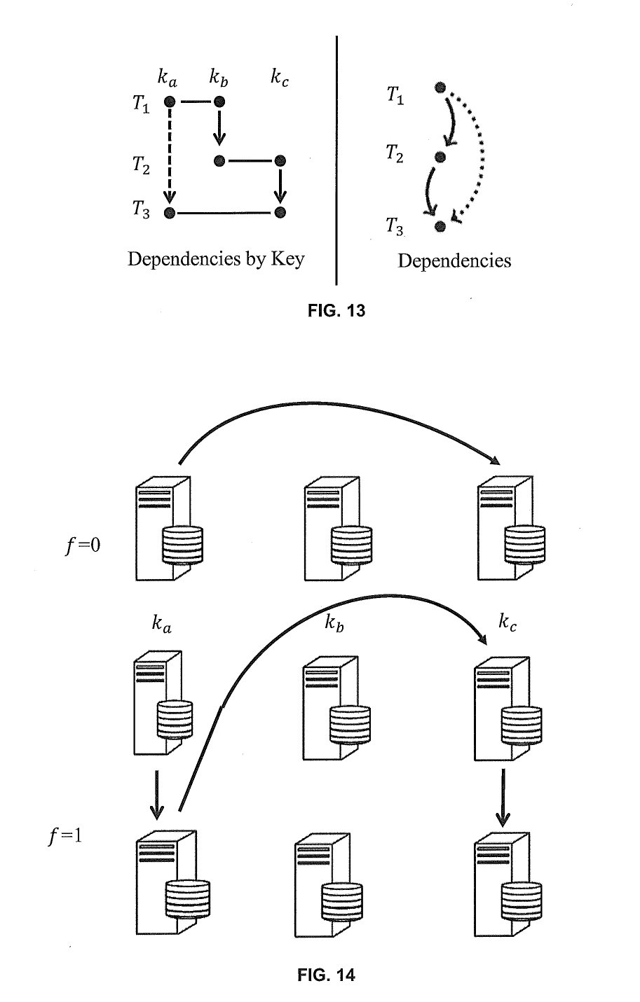

A designated server S_{ω} needs to convert a needs ordering dependency into a happens-before dependency in a manner that maintains serializability. If done incorrectly, the server could introduce a dependency cycle. For instance, FIG. 13 illustrates a case where transactions T₁ and T₃ are ordered by the server holding kₐ. If this server were to order T₃→T₁, the dependency graph would contain a cycle. Specifically, FIG. 13 illustrates linear transactions capture dependencies between transactions. Three transactions are shown, each of which touches two keys. The diagram on the left shows how happens-before relationships (arrows) are detected on a per-key basis. The dashed arrow is a transitively-defined dependency. The diagram on the right shows the overall acyclic dependency graph.

To avoid such failures to serialize, designated servers transform needs-ordering dependencies into happens-before dependency only when they have a complete view of the dependency graph. To obtain this, the server waits until it receives a “commit” message for every prepared-but-not-committed compatible transaction. Once a server has this information, it may consult the dependencies of all overlapping, compatible transactions, and compute the correct direction for the needs-ordering dependency. In the example above, the server holding kₐ should order T₁→T₃ based on the embedded dependencies of all transactions, and lead to a serializable order.

The linear transactions protocol ensures correctness by ensuring that the dependency graph is acyclic. This section provides a sketch of why the dependency management maintains the anti-cycle invariant at all times. The observation to make here is that for any possible cycle that could exist, there is always one happens-before dependency that, if directed correctly, would prevent the cycle and preserve the anti-cycle invariant. The protocol does this by treating every needs-ordering dependency as a case that may introduce a cycle. Given sufficient information about other edges in the graph, it's always possible to make this decision.

The protocol guarantees that sufficient dependency information is available by first capturing all dependencies, and then making sure that all dependencies propagate through the whole system. All dependencies are inherently captured because each server checks local state for compatible transactions. The dependencies propagate because servers only add, and never remove, dependencies. It should be noted that servers must consult the embedded dependencies for both transactions in a needs-ordering relationship before a happens-before relationship may be established.

Turning again to FIG. 13, the dependency T₁→T₂ may be introduced either as a happens-before dependency when T₁ commits before T₂ prepares at k_{b}, or as a needs-ordering dependency when T₂ prepares before T₁ commits at k_{b}. The former case causes dependencies to propagate through the messages for T₂ and T₃ while the latter case causes the server holding k_{b} to dictate the order and embed the dependency in T₁'s “commit” message. In both cases, the server holding kₐ has sufficient information to infer that T₁→T₃ using the relationships T₁→T₂ and T₂→T₃.

In a large-scale deployment, failures are inevitable. Linear transactions provide a natural way to overcome such failures. Specifically, linear transactions can easily permit a subchain of f+1 replicas to be inlined into a longer chain in place of a single data server. This allows the system to remain available despite up to f failures for any particular key. Within the subchain, chain replication maintains a well-ordered series of updates to the underlying, replicated data. Operations that traverse the linear transaction chain in the forward direction pass forward through all inlined chains. Likewise, operations that traverse the chain in reverse traverse inlined chains in reverse.

FIG. 14 shows a linear transaction that traverses an f=0 configuration and the same transaction under an f=1 configuration. Fault tolerance is achieved through replication. The top set of servers shows an f=0 configuration that tolerates no failures. By inlining replicas within the linear transaction's chain, the f=1 deployment shown on the bottom can withstand one server failure for each key. The linear transaction is threaded through all relevant replicas.

This fault tolerance mechanism naturally tolerates network partitions as well. Servers that become separated from the system during a partition will not make progress because they are partitioned from the cluster, and any transaction that commits is guaranteed to have traversed all servers in the chain. To ensure liveliness during the partition, the system treats servers that become partitioned as if they are failed nodes. After the partition heals, these servers may re-assimilate into the cluster. Epoch identifiers in messages prohibit the mixing of messages from different configurations of the system. It should be noted that the notion of fault-tolerance provided by linear transactions is different from the notion of durability within traditional databases. While durability ensures that data may be re-read from disk after a failure, the system remains unavailable during the failure and recovery period; in contrast, fault tolerance ensures that the system remains available up to a threshold of failures.

The protocol ensures that transactions execute atomically; either all operations take effect, or none do. Since servers can never convert a “commit” message into an “abort” or vice-versa, all nodes on a chain unanimously agree on the outcome by the time an acknowledgement is sent to the client. In the event of a failure, the chain reconfigures and queued messages are re-sent, enabling the chain to continue in unison.

The consistency of the data store is preserved by linear transactions. With each commit, the system is taken from one valid state to the next. All invariants that an application may maintain on the data store are upheld by the linear transactions protocol. Transactions are fully consistent with non-transactional key operations issued against the data store. Upon receipt of a key operation for a key that is currently read or written by a transaction, the system delays the processing of the key operation until after the transaction commits or aborts. This renders non-transactional key operations compatible with the linear transactions.

Clients' optimistic reads and writes are consistent with one-copy serializability. Over the course of the transaction, the client collects the set of all values it read. A committed linear transaction guarantees that the checks specified by the client are valid at commit time. Although the values read may change (and change back) between when the client first reads, and when the transaction commits, the client is unable to distinguish between this case and a case in which the client read the values immediately before commit.

Linear transactions are non-blocking and guaranteed to make progress in the normal case of no failures. A transaction does not spuriously abort; it will only be aborted or delayed because of a concurrently executed, conflicting transaction. For each aborted transaction, there always exists another transaction that made progress at the key generating the conflict. Because there are only a finite number of transactions executing at any given time, there will always be at least one transaction that commits successfully causing others to abort. This satisfies the non-blocking criteria.

Since the linear transactions protocol collects information about transactions without bound, a simple gossip-based garbage collector with predictable overheads keeps the size of these sets in check. Specifically, each transaction is identified by a unique id, for example a 128-bit id, assigned to it by the first storage server in its chain, created by concatenating the IP address and port of the server with a monotonic counter. These transaction identifiers are strictly increasing, allowing each server to broadcast the lowest-numbered transaction that has prepared but not yet committed or aborted. Each server periodically broadcasts the lowest transaction id that has prepared but not committed or aborted. Upon collecting such broadcasts from its peers, a server can completely flush all information related to previous transactions. This enables large numbers of transactions to be garbage collected using a constant amount of background traffic.

The protocol according to the invention provides complete bindings for C, C++, and Python and supports a rich API that supports string, integer, float, list, set, and map types and complex atomic operations on these objects, such as conditional put, string prepend and append, integer addition/subtraction/multiplication/division, list prepend, list append, set union/intersection/subtraction, and atomic string or integer operations on values contained within maps and search over secondary values. Furthermore, the protocol of the invention supports nested transactions that allow applications to create an arbitrary number of transaction scopes, and commit or abort each one independently.

Clients connect to the protocol according to the invention using an object through which a client can issue immediate, non-transactional operations to the data store. Clients create transaction objects using a “begin transaction” call. The transaction object provides an exact interface enabling applications to easily wrap operations within a transaction. Whereas non-transactional code issues operations immediately to the data store, the transaction object stores reads and writes in a per-transaction local key-value store. At commit time, the read and modified objects are aggregated by the client and sent en-masse to the data store. Transactions that cross schema boundaries are natively supported. The linear transaction incorporates servers from different schemas into the chain just as it does for operations on different keys.

The protocol also supports arbitrarily nested transactions. Clients may perform a transaction within an ongoing transaction. Every nested transaction maintains its own locally managed transaction context. Each read within a nested transaction passes through all parent transactions before finally reaching the key-value store, stopping at the first key-value store that contains a copy of the object. At commit time, the client atomically compares a nested transaction with its parent, and can locally make the decision to commit or abort. When the nested transaction commits, it atomically updates its parent's transaction context. When the root parent of all nested transactions commits, it includes all the checks seen by any nested transactions started within. The resulting linear transaction commits the changes for both the parent transaction and all linear transactions.

A coordinator is used to keep track of metastate about cluster membership. A replicated state machine (RSM) maintains and distributes a mapping that determines how objects are mapped to servers. Clients consult this mapping to issue reads and writes to the appropriate servers, while servers use the mapping to dynamically determine their next and previous servers for each linear transaction's chain.

Each time a server reports to the coordinator that a failure has disrupted one or more chains, the coordinator issues a new configuration acknowledging this report. Embedded within the configuration is a strictly increasing epoch number that uniquely identifies the configuration. All server-to-server messages contain this epoch number, enabling servers to discard late-arriving messages from a previous epoch. Servers send each prepare/commit/abort message at most once per epoch to ensure that other servers may detect and drop late-arriving messages. Because metadata about committed and aborted transactions persists on the servers until garbage collection, and garbage collection happens only after an operation completely traverses the chain, servers are guaranteed to be able to retransmit “prepare” messages for incomplete transactions and receive the same response. Any “commit” or “abort” message generated in the previous epoch is ignored; only messages from current epochs are accepted.

The coordinator is implemented on top of the redacted replicated state machine library. Redacted uses chain replication to sequence the input to the state machine and a quorum-based protocol to reconfigure chains on failure. It is contemplated that the coordinator can easily be taken on by configuration services such as ZooKeeper or Chubby.

Transaction management has been an active research topic since the early days of distributed database systems. Existing approaches can be broadly classified into the following categories based on the mechanism they employ for ordering and atomicity guarantees.

Early RDBMS systems relied on physically centralized transaction managers. While centralization greatly simplifies the implementation of a transaction manager, it poses a performance and scalability bottleneck and acts as a single point of failure. However, the invention is based on a distributed architecture.

The traditional approach to distributing transaction management is to provide a set of specialized transaction managers that serve as intermediaries between clients and back-end data servers. These transaction managers perform lock or timestamp management, and employ a protocol, such as two phase commit (2PC), for coordination.

Some systems physically separate and unbundle transaction management logic from the servers that store the data. Such a separation allows the design of the transactional component to be independent from the design of the rest of the system, such as data layout and caching. Instead of separating transactions from the underlying storage, the invention integrates transaction management with the underlying servers that hold the data and threads transactional updates through the storage components. This coupling refactors transaction management out of dedicated servers, distributes it across a larger set of hosts and leads to an efficient implementation.

Like the consensus-based approaches, the invention relies on a fault-tolerant agreement protocol, inspired by chain replication and value-dependent chaining, to achieve strong consistency and atomicity. The invention does not partition the data or the consensus group, and does not place any restrictions on which keys may appear in a transaction. Furthermore, the invention uses no special, designated hosts to sequence transactions or to perform consensus; instead, only those servers that house the relevant data (plus transitive closure) partake in the agreement protocol. More importantly, Paxos-based approaches impose a significant performance overhead, whereas the transactions according to the invention are fast with minimal overhead.

Some notable systems take advantage of synchronized clocks to assign timestamps to transactions as well as determine when they are safe to commit. The invention makes no assumptions about clock synchrony; processes' clocks may proceed at different rates without negatively affecting either performance or safety.

Some systems have explored how to factor transaction management functionality to clients. According to the invention, transactions do not rely upon the client to remain available. Instead, transactions are fully fault-tolerant and do not require background processes to compensate for failures.

The protocol according to the invention focuses not on low-latency geographically distributed transactions, but on providing fully serializable transactions within a single datacenter. In addition, the transaction commit uses a set of checks and writes to validate and apply a client's changes and reduces coordination where possible. The invention targets workloads that make use of key-value stores and is not designed for online transaction processing (OLTP) applications.

In one embodiment described, a key-value store provides one-copy-serializable ACID transactions. The linear transactions protocol enables the system to completely distribute the task of ordering transactions. Consequently, transactions on separate servers do not require expensive coordination and the number of servers that process a transaction is independent of the number of servers in the system. The system achieves high performance on a variety of standard benchmarks, performing nearly as well as the non-transactional key-value store that the invention builds upon.

The described embodiments are to be considered in all respects only as illustrative and not restrictive, and the scope of the invention is not limited to the foregoing description. Those of skill in the art may recognize changes, substitutions, adaptations and other modifications that may nonetheless come within the scope of the invention and range of the invention.

1. A method of operation of a computer for managing time dependencies in a distributed system including two or more subsystems with each subsystem including at least one event, wherein the computer comprises a central control unit, a storage system, and a network interface device, comprising the steps of:
receiving by the central control unit through the network interface device two or more events from the two or more subsystems;
building by the central control unit an event dependency graph, wherein the event dependency graph includes a plurality of vertices with each vertex representing an event and a plurality of edges with each edge representing a happens-before relationship;
storing the event dependency graph in the storage system;
tracking by the central control unit dependencies between the two or more events that traverse the two or more subsystems;
selecting by the central control unit an order of the two or more events as late as possible; and
executing in each subsystem the two or more events according to the order selected by the central control unit.

2. The method according to claim 1, wherein each edge of the plurality of edges is added to the event dependency graph when dependencies are added between the two or more events.

3. The method according to claim 1, wherein the plurality of edges includes specially marked edges representing explicitly created happens-before dependencies.

4. The method according to claim 1, wherein the plurality of edges includes automatically deduced edges representing transitively-computed dependencies not explicitly instantiated.

5. The method according to claim 1 further comprising the step of using the event dependency graph to answer queries regarding the ordering between two or more new events.

6. The method according to claim 1 further comprising the step of adding a new event to the event dependency graph by creating a vertex with a globally unique identifier.

7. The method according to claim 6 further comprising the step of using the globally unique identifier to query the event dependency graph to establish happens-before relationships between vertices.

8. The method according to claim 1, wherein the order is a hard constraint that the two or more events must be ordered in a requested manner.

9. The method according to claim 8, wherein the order is aborted when the two or more events cannot be ordered in the requested manner.

10. The method according to claim 8, wherein the order is a soft preference that the two events be ordered in a requested sequence if permitted by the previously established happens-before relationships.

11. The method according to claim 8, wherein the events that have been executed to completion are excised from the event dependency graph, thereby maintaining a size for the event dependency graph that is proportional to the quantity of active events.

12. The method according to claim 1 further comprising the steps of:
replicating by the central control unit the event dependency graph to obtain a replicated event dependency graph; and
providing by the central control unit to each subsystem the replicated event dependency graph.

13. A method of operation for coordinating distributed transactions on top of a sharded, distributed data store in a network, wherein the network comprises a plurality of servers and a plurality of clients, comprising the steps of:
selecting by a client one or more keys to obtain selected keys, wherein the selected keys deterministically determine a chain for each transaction of a plurality of transactions;
mapping by the client each selected key using a key-value store;
processing by the client each transaction through its corresponding chain through a forward pass and a backward pass;
checking each transaction of the plurality with one or more concurrent transactions;
applying by each server of the plurality of servers write keys for which the server is mapped to the key-value store;
assigning an order to each transaction of the plurality of transactions; and
executing each transaction of the plurality of transactions.

14. The method according to claim 13, wherein the forward pass includes the steps of:
determining overlapping transactions;
establishing happens-before relationships; and
validating previous reads.

15. The method according to claim 13, wherein the backward pass includes one step selected from the group of:
aborting the transaction; and
committing the transaction.

16. The method according to claim 13, wherein the one or more concurrent transactions operate on one or more keys separate from the plurality of keys of the transaction and require no consideration.

17. The method according to claim 13, wherein the one or more concurrent transactions operate on one or more keys that are the same as the plurality of keys of the transaction.

18. The method according to claim 17, wherein the one or more concurrent transactions are compatible transactions and are prepared concurrently with each transaction of the plurality of transactions and forwarded to a server in the chain.

19. The method according to claim 17, wherein the one or more concurrent transactions are conflicting transactions and are aborted.

20. The method according to claim 13, wherein the processing step further comprises the step of capturing all dependency information as each transaction of the plurality of transactions traverses the chain.
